(19) United States
(12) Patent Application Publication
(10) Pub. No.: US 2024/0318905 A1
(43) Pub. Date: Sep. 26, 2024

(54) HYDROGEN LIQUEFACTION DEVICE AND LIQUEFIED HYDROGEN SUPPLY SYSTEM

(71) Applicant: H2CREO Corp., Dover, DE (US)

(72) Inventors: JONG H BAIK, Titusville, FL (US); JEONG HYUN IM, Gangwon-do (KR); HYUNG JIN KIM, Gyeonggi-do (KR)

(21) Appl. No.: 18/406,917

(22) Filed: Jan. 8, 2024

Related U.S. Application Data
(60) Provisional application No. 63/454,153, filed on Mar. 23, 2023.

(51) Int. Cl. F25J 1/00; B64F 1/28; F17C 7/04

(52) U.S. Cl. CPC F25J 1/001; F17C 7/04; B64F 1/28; F17C 2201/0109; F17C 2201/032; F17C 2205/0323; F17C 2205/0355; F17C 2221/012; F17C 2227/0135; F17C 2227/0353; F17C 2260/038; F17C 2260/042; F17C 2270/0171

(57) ABSTRACT

The present disclosure relates to a hydrogen liquefaction device, which may comprise: a cradle for forming an accommodating space in which a mobile storage container capable of storing liquefied hydrogen or a mobility that uses liquefied hydrogen as a power source can be accommodated; and a liquefier installed on one side of the cradle, cooling hydrogen in a gaseous state supplied from outside to a temperature which is equal to or below liquefaction temperature to generate liquefied hydrogen in a liquid state so as to supply liquefied hydrogen to the mobile storage container or the mobility, or recover vaporized gas generated from the mobile storage container in which liquefied hydrogen is stored or from the mobility for re-liquefaction into liquefied hydrogen.

### CROSS REFERENCE TO RELATED APPLICATIONS

The present application claims the benefit of and priority to U.S. Provisional Application Ser. No. 63/454,153, filed on Mar. 23, 2023, the entire contents of which is incorporated herein by reference.

### BACKGROUND

### 1. Field of Invention

The present disclosure relates to a hydrogen liquefaction device and liquefied hydrogen supply system, and more particularly, to a hydrogen liquefaction device and liquefied hydrogen supply system capable of supplying liquefied hydrogen to a mobile storage container or a mobility that uses liquefied hydrogen as a power source or re-liquefying generated vaporized gas by using a liquefier configured to be movable.

### 2. Description of Related Art

Conventionally, fossil fuels such as oil, coal, and natural gas have been mainly used as energy sources, but these resources have a disadvantage of being finite and emitting carbon compounds that cause global warming. Accordingly, technologies are being developed that use hydrogen as an energy source, which can produce electricity in an eco-friendly and efficient manner, has no risk of depletion, is sustainable, and has advantages of being easy to store and transport. In general, hydrogen has a disadvantage of being difficult to store or transport due to its large volume as it exists in gaseous state at room temperature. Accordingly, a method of using liquefied hydrogen by liquefying hydrogen at −253 degrees Celsius is mainly used, and such liquefied hydrogen should be continuously maintained at a cryogenic temperature of −253 degrees Celsius during transportation and storage processes.

Recently, there has been a growing number of users requiring small quantities of liquefied hydrogen, leading to development of mobile supply technologies. In general, hydrogen liquefiers are limited by installation environment, such as utilities required for liquefaction of hydrogen, a power supply unit, a coolant chiller, a pneumatic unit, an gaseous hydrogen supply unit, a control system, explosion protection safety devices, and safety regulations, thus a system capable of supplying liquefied hydrogen in a mobile manner is required in order to easily supply liquefied hydrogen when liquefied hydrogen is needed on remote islands or in small-scale uses.

Conventional mobile liquefied hydrogen supply systems are mainly liquefied hydrogen tank structures in which a liquefied hydrogen storage container is installed inside a vacuum container equipped with a cryocooler, and a liquefier and a storage tank are directly connected within a vacuum chamber. Such a mobile liquefied hydrogen supply system is a type of transport by connecting a double vacuum transport hose on a cryocooler to a storage tank and applying pressure there in order to transport liquefied hydrogen to a mobile storage container or a mobility storage container for small-scale uses. However, a significant amount of vaporized gas may be generated due to heat losses, which inevitably occur from the vacuum transport hose that is exposed to room temperature or in a process of cooling the mobile storage container or mobility storage container at the beginning of supply.

Conventional mobile liquefied hydrogen supply systems had a problem in that a large amount of hydrogen gas was lost by venting vaporized gas generated in this manner into atmosphere as it is.

### Problems to be Solved

The present disclosure is to resolve various problems including the above problem, and has a purpose of providing a hydrogen liquefaction device and liquefied hydrogen supply system, which is capable of including utilities required for liquefaction of hydrogen, a power supply unit, a coolant chiller, a pneumatic unit, an gaseous hydrogen supply unit, a control system, an explosion protection safety device, and the like, which are downsized, inside a container that is movable by a mobile trailer or a transport means; capable of separating a storage container thereby storing liquefied hydrogen as needed and using liquefied hydrogen immediately; and capable of re-liquefying vaporized gas generated by heat loss so as to be able to use liquefied hydrogen easily without loss of hydrogen gas. However, these problems are exemplary, and a scope of the present disclosure is not limited thereto.

### SUMMARY

According to an aspect of the present disclosure, a hydrogen liquefaction device is provided. The hydrogen liquefaction device may comprise a cradle that forms an accommodating space in which a mobile storage container capable of storing liquefied hydrogen or a mobility that uses liquefied hydrogen as a power source can be accommodated; and a liquefier installed on one side of the cradle, cooling hydrogen in a gaseous state supplied from outside to a temperature which is equal to or below liquefaction temperature to generate liquefied hydrogen in a liquid state so as to supply liquefied hydrogen to the mobile storage container or the mobility, or recover vaporized gas generated from the mobile storage container in which liquefied hydrogen is stored or from the mobility for re-liquefaction into liquefied hydrogen.

According to an embodiment of the present disclosure, the liquefier may include a liquefaction chamber that forms a liquefaction space into which hydrogen in a gaseous state supplied from outside is flowed and liquified; a cryocooler installed on one side of the liquefaction chamber, cooling hydrogen to a temperature which is equal to or below liquefaction temperature so as to liquefy hydrogen flowed into the liquefaction space; a supply line that connects an external hydrogen supply source and the liquefaction chamber so as to supply hydrogen to the liquefaction chamber; a discharge line that connects the liquefaction chamber and the mobile storage container, or connects the liquefaction chamber and the mobility, so as to supply liquefied hydrogen generated in the liquefaction chamber to the mobile storage container or to the mobility; and a recovery line that connects the mobile storage container and the liquefaction chamber, or connects the mobility and the liquefaction chamber, so as to recover vaporized gas generated from the mobile storage container or the mobility.

According to an embodiment of the present disclosure, the supply line may be connected to a supply port formed at an upper part of the liquefaction space, where liquefied hydrogen is accommodated, in the liquefaction chamber, so as to allow hydrogen supplied from the hydrogen supply source to flow into the upper part of the liquefaction space, and the discharge line may be connected to a discharge port that is formed on a lower side of the liquefaction chamber, so as to discharge hydrogen generated in the liquefaction chamber to the accommodating space.

According to an embodiment of the present disclosure, the recovery line, during a process of recovering vaporized gas generated from the mobile storage container or the mobility towards the liquefaction chamber, may be connected to a recovery port that connects the lower side of the liquefaction chamber and the supply port, so as to allow vaporized gas to flow into the liquefaction space in a mixed state with hydrogen supplied from the hydrogen supply source.

According to an embodiment of the present disclosure, the liquefier may further include a vent port connected to the recovery line so as to vent at least a portion of vaporized gas generated and recovered from the mobile storage container or the mobility to outside.

According to an embodiment of the present disclosure, the vent port may include at least one or more following lines: a first vent line including a bypass valve so as to control pressure and flow rate of vaporized gas recovered to the recovery line; and a second vent line including a relief valve so that pressure of vaporized gas recovered to the recovery line does not exceed a predetermined pressure.

According to an embodiment of the present disclosure, the supply line, the discharge line, and the recovery line may be connected to the liquefaction chamber, and to at least one of the mobile storage container and the mobility by a quick connector.

According to an embodiment of the present disclosure, each of the supply line, the discharge line, and the recovery line may be formed as a double-pipe shaped vacuum hose, including a vacuum-insulated space.

According to an embodiment of the present disclosure, the mobile storage container or the mobility may be configured to be supplied with liquefied hydrogen from the liquefier while being positioned in the accommodating space of the cradle.

According to an embodiment of the present disclosure, the liquefier may be configured to open all valves on the supply line, the discharge line, and the recovery line so as to supply liquefied hydrogen to the mobile storage container or the mobility, to recover and re-liquefy vaporized gas generated from the mobile storage container or the mobility, and to resupply re-liquefied hydrogen to the mobile storage container or the mobility.

According to an embodiment of the present disclosure, the mobile storage container or the mobility may be configured to be supplied with liquefied hydrogen from an external liquefied hydrogen storage container while being positioned outside the cradle.

According to an embodiment of the present disclosure, the liquefier may be configured to close the valves on the supply line and the discharge line and to open the valve on the recovery line so as to recover and re-liquefy vaporized gas generated from the mobile storage container or the mobility to temporarily store re-liquefied hydrogen in the liquefaction chamber.

According to the other aspect of the present disclosure, a liquefied hydrogen supply system is provided. The liquefied hydrogen supply system may comprise a transport module including a mobile trailer or a container that is movable by being towed by a transport means or loaded on the transport means; a hydrogen liquefaction device installed on one side of the transport module to generate hydrogen in a gaseous state into liquefied hydrogen in a liquid state; a utility module installed on other side of the transport module to supply utilities required for the hydrogen liquefaction device; and a hydrogen supply module installed on another side of the transport module to store or generate hydrogen in a gaseous state to be supplied to the hydrogen liquefaction device, wherein the hydrogen liquefaction device may include a cradle that forms an accommodating space in which a mobile storage container capable of storing liquefied hydrogen or a mobility that uses liquefied hydrogen as a power source can be accommodated, being formed to be movable; and a liquefier installed on one side of the cradle, cooling hydrogen in a gaseous state supplied from the hydrogen supply module to a temperature which is equal to or below liquefaction temperature to generate liquefied hydrogen in a liquid state so as to supply liquefied hydrogen to the mobile storage container or the mobility, or recover vaporized gas generated from the mobile storage container in which liquefied hydrogen is stored or from the mobility for re-liquefaction into liquefied hydrogen.

According to the other embodiment of the present disclosure, the liquefier may include a liquefaction chamber that forms a liquefaction space into which hydrogen in a gaseous state supplied from the hydrogen supply module is flowed and liquified; a cryocooler installed on one side of the liquefaction chamber, cooling hydrogen to a temperature which is equal to or below liquefaction temperature so as to liquefy hydrogen flowed into the liquefaction space; a supply line that connects the hydrogen supply module and the liquefaction chamber so as to supply hydrogen to the liquefaction chamber; a discharge line that connects the liquefaction chamber and the mobile storage container, or connects the liquefaction chamber and the mobility so as to supply liquefied hydrogen generated in the liquefaction chamber to the mobile storage container or to the mobility; and a recovery line that connects the mobile storage container and the liquefaction chamber, or connects the mobility and the liquefaction chamber, so as to recover vaporized gas generated from the mobile storage container or the mobility.

According to the other embodiment of the present disclosure, the liquefied hydrogen supply system may further include a precooling module installed on the supply line to precool hydrogen that is supplied to the liquefaction chamber.

According to the other embodiment of the present disclosure, the utility module may include a vacuum pump that forms vacuum pressure of inside and a pipe of the hydrogen liquefaction device; a control unit that controls the hydrogen liquefaction device; a power supply unit that supplies power for operation of the hydrogen liquefaction device; and a coolant chiller that supplies coolant to the compressor of the cryocooler, and further including following utilities formed in an explosion prevention area: a gas storage unit that stores utility gas that includes at least one of helium (He) to be used to purge inside and the pipe of the hydrogen liquefaction device or as a refrigerant in the cryocooler, nitrogen (N2) for diluting hydrogen concentration when venting vaporized gas, and liquid nitrogen (LN2) to be used as a refrigerant in the precooling module; and a pneumatic unit that provides pneumatic pressure so as to allow valves installed on the supply line, the discharge line, and the recovery line to be operated by pneumatic pressure.

According to the other embodiment of the present disclosure, the hydrogen supply module may include at least one of a water electrolyzer that electrolyzes water to produce hydrogen in a gaseous state; and a hydrogen cylinder that stores hydrogen in a gaseous state.

According to the other embodiment of the present disclosure, the transport module may form an explosion prevention area, which includes an area where the hydrogen liquefaction device is installed, an area where the hydrogen supply module is installed, and an area where a gas storage unit and a pneumatic unit are installed.

According to the other embodiment of the present disclosure, the transport module may include a detecting sensor installed in the explosion protection area to detect hydrogen leaked inside the explosion protection area.

According to another aspect of the present disclosure, a hydrogen liquefaction device is provided. The hydrogen liquefaction device may comprise a cradle that forms an accommodating space in which a mobile storage container capable of storing liquefied hydrogen or a mobility that uses liquefied hydrogen as a power source can be accommodated, being formed to be movable; and a liquefier installed on one side of the cradle, cooling hydrogen in a gaseous state supplied from outside to a temperature which is equal to or below liquefaction temperature to generate liquefied hydrogen in a liquid state so as to supply liquefied hydrogen to the mobile storage container or the mobility, or recover vaporized gas generated from the mobile storage container in which liquefied hydrogen is stored or from the mobility for re-liquefaction into liquefied hydrogen; wherein the liquefier may include a liquefaction chamber that forms a liquefaction space into which hydrogen in a gaseous state supplied from outside is flowed and liquified; a cryocooler installed on one side of the liquefaction chamber, cooling hydrogen to a temperature which is equal to or below liquefaction temperature so as to liquefy hydrogen flowed into the liquefaction space; a supply line that connects an external hydrogen supply source and the liquefaction chamber so as to supply hydrogen to the liquefaction chamber; a discharge line that connects the liquefaction chamber and the mobile storage container, or connects the liquefaction chamber and the mobility so as to supply liquefied hydrogen generated in the liquefaction chamber to the mobile storage container or to the mobility; a recovery line that connects the mobile storage container and the liquefaction chamber, or connects the mobility and the liquefaction chamber so as to recover vaporized gas generated from the mobile storage container or the mobility; and a vent port connected to the recovery line so as to vent at least a portion of vaporized gas generated and recovered from the mobile storage container or the mobility to outside; and the supply line may be connected to a supply port formed at an upper part of the liquefaction space, where liquefied hydrogen is accommodated, in the liquefaction chamber, so as to allow hydrogen supplied from the hydrogen supply source to flow into the upper part of the liquefaction space, the discharge line may be connected to a discharge port that is formed on a lower side of the liquefaction chamber, so as to discharge hydrogen generated in the liquefaction chamber to the accommodating space, the recovery line, during a process of recovering vaporized gas generated from the mobile storage container or the mobility towards the liquefaction chamber, may be connected to a recovery port that connects the lower side of the liquefaction chamber and the supply port, so as to allow vaporized gas to flow into the liquefaction space in a mixed state with hydrogen supplied from the hydrogen supply source, and the vent port may include at least one or more following lines: a first vent line including a bypass valve so as to control pressure and flow rate of vaporized gas recovered to the recovery line; and a second vent line including a relief valve so that pressure of vaporized gas recovered to the recovery line does not exceed a predetermined pressure.

According to an embodiment of the present disclosure as described above, a hydrogen liquefaction device and liquefied hydrogen supply system, which is capable of including utilities required for liquefaction of hydrogen, a power supply unit, a coolant chiller, a pneumatic unit, an gaseous hydrogen supply unit, a control system, an explosion protection safety device, and the like, which are downsized, inside a container that is movable by a mobile trailer or a transport means; capable of separating a storage container thereby storing liquefied hydrogen as needed and using liquefied hydrogen immediately; and capable of re-liquefying vaporized gas generated by heat loss to use liquefied hydrogen easily without loss of hydrogen gas, can be implemented. However, a scope of the present disclosure is not limited by these effects.

### BRIEF DESCRIPTION OF THE DRAWINGS

FIG. 1 is a cross-sectional view schematically showing a hydrogen liquefaction device on which a mobile storage container is mounted, according to an embodiment of the present disclosure.

FIG. 2 is a cross-sectional view schematically showing a hydrogen liquefaction device from which a mobile storage container is separated, according to an embodiment of the present disclosure.

FIG. 3 is a cross-sectional view schematically showing a hydrogen liquefaction device on which a mobility is mounted, according to an embodiment of the present disclosure.

FIG. 4 is a cross-sectional view schematically showing a hydrogen liquefaction device from which a mobility is separated, according to an embodiment of the present disclosure.

FIG. 5 is a cross-sectional view showing an embodiment of re-liquefying vaporized gas generated in a mobility during supplying of liquefied hydrogen by using a hydrogen liquefaction device, according to an embodiment of the present disclosure.

FIG. 6 is a cross-sectional view schematically showing a liquefied hydrogen supply system including a hydrogen liquefaction device, according to an embodiment of the present disclosure.

FIG. 7 is a cross-sectional view schematically showing a liquefied hydrogen supply system including a hydrogen liquefaction device, according to an embodiment of the present disclosure.

### DETAILED DESCRIPTION

Hereinafter, various preferred embodiments of the present disclosure will be described in detail with reference to the appended drawings.

The embodiments of the present disclosure are provided to more completely explain the present disclosure to those skilled in the art, and the following embodiments can be modified into various other forms, and the scope of the present disclosure is not limited to the following embodiments. Instead, these embodiments are provided to enhance the faithfulness and completeness of the present disclosure and to fully convey the technical ideas of the present disclosure to those skilled in the art. Furthermore, the thickness and size of each layer in the drawings are exaggerated for convenience and clarity of explanation.

Hereinafter, embodiments of the present disclosure will now be described with reference to drawings that schematically show ideal embodiments of the present disclosure. In the drawings, variations of the depicted shape may be expected, for example, depending on manufacturing technology and/or tolerances. Accordingly, embodiments of the present disclosure should not be construed as being limited to the specific shape of the area shown in this specification, but should include, for example, changes in shape resulting from manufacturing.

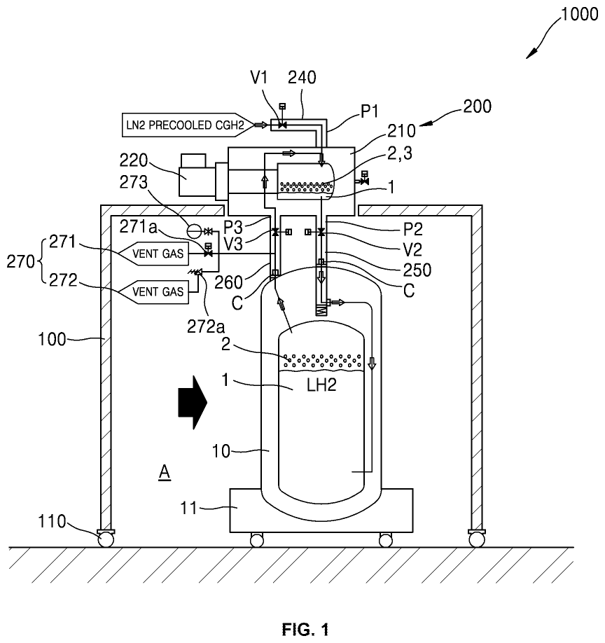

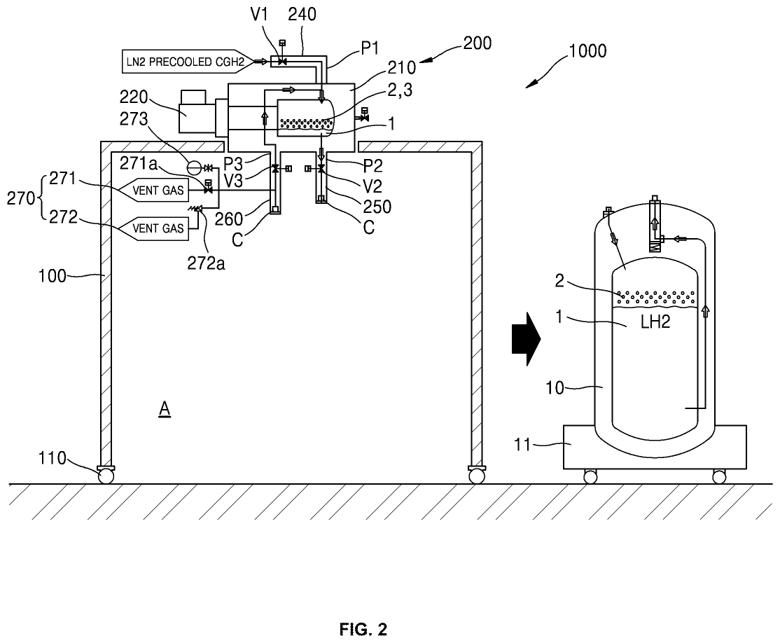

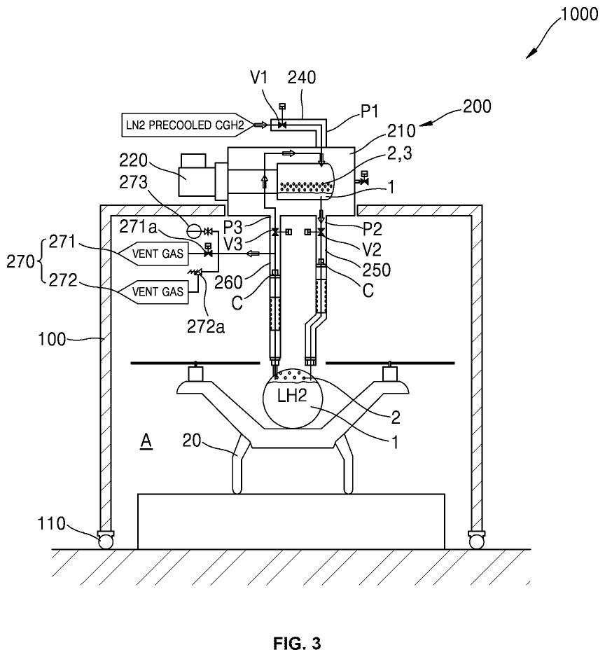

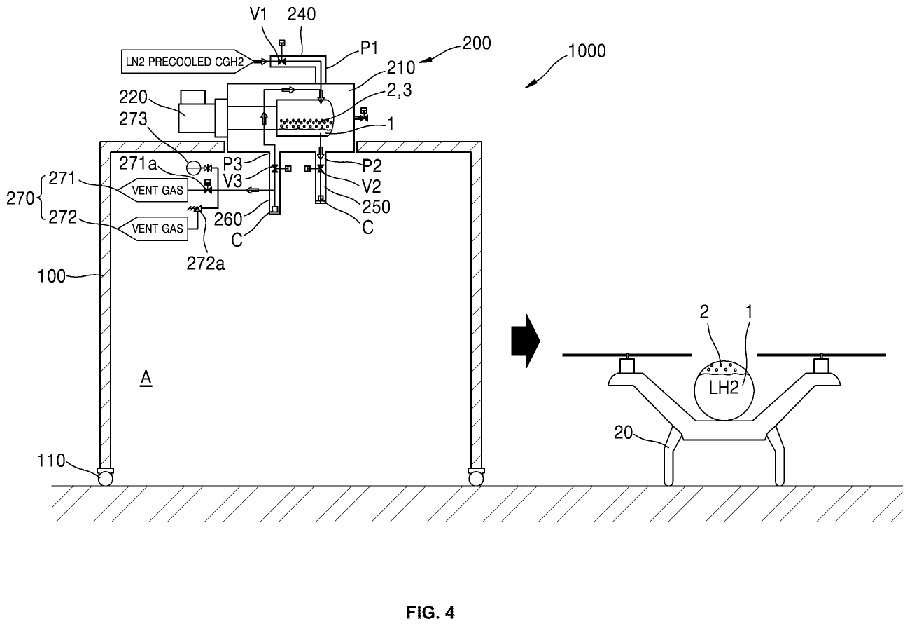

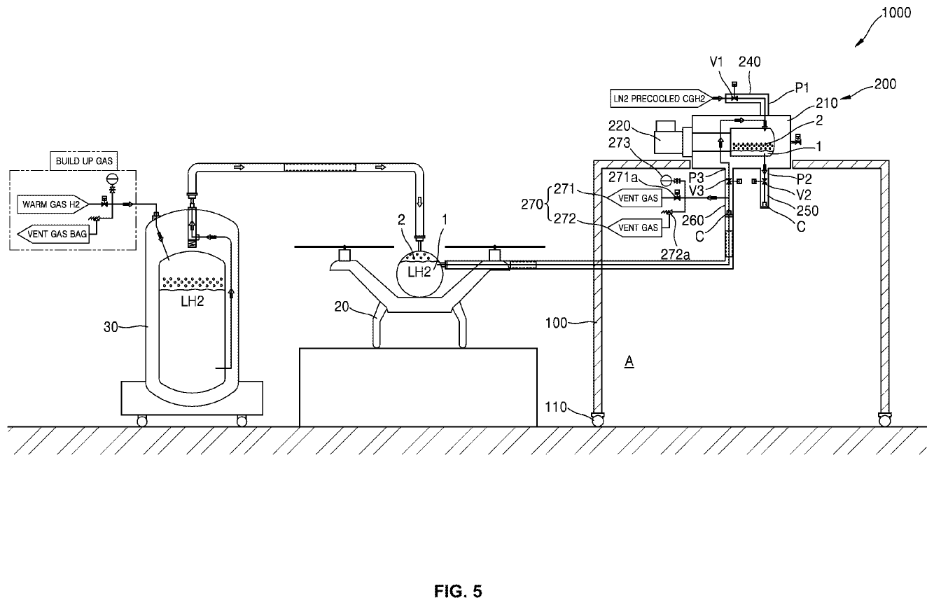

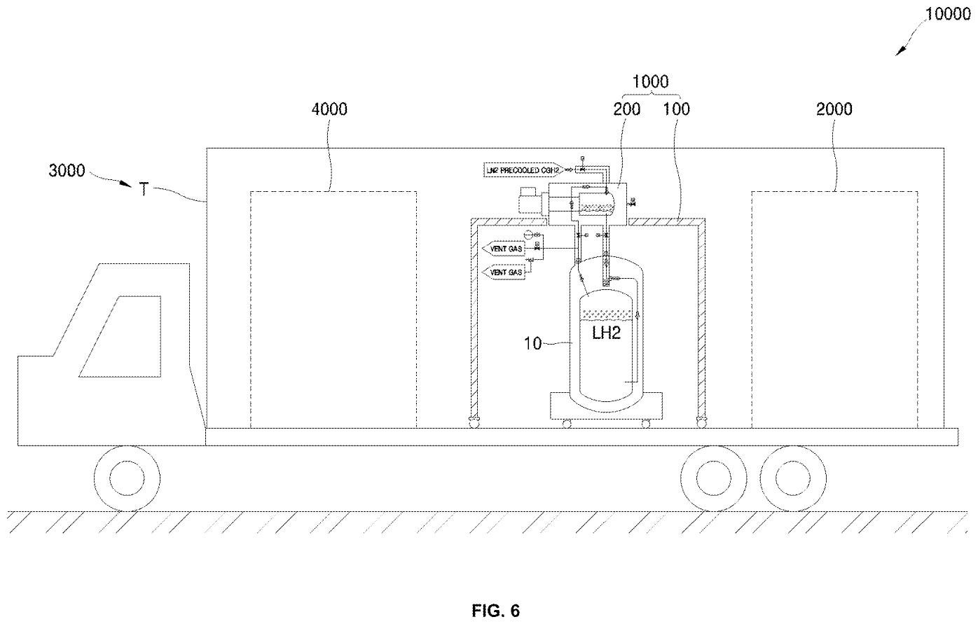

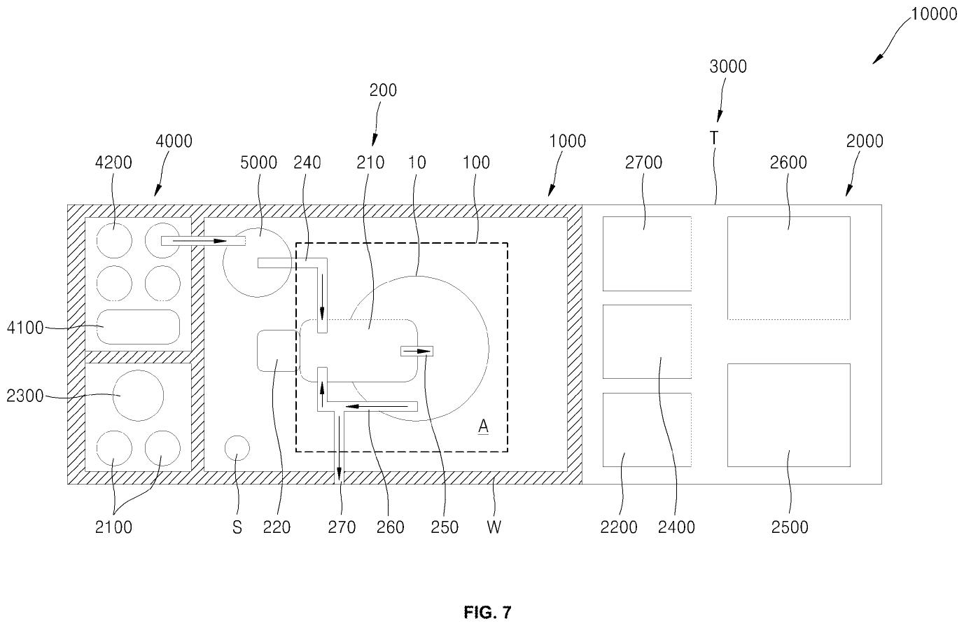

FIG. 1 is a cross-sectional view schematically showing a hydrogen liquefaction device on which a mobile storage container is mounted, according to an embodiment of the present disclosure; FIG. 2 is a cross-sectional view schematically showing a hydrogen liquefaction device from which a mobile storage container is separated, according to an embodiment of the present disclosure; FIG. 3 is a cross-sectional view schematically showing a hydrogen liquefaction device on which a mobility is mounted, according to an embodiment of the present disclosure; and FIG. 4 is a cross-sectional view schematically showing a hydrogen liquefaction device from which a mobility is separated, according to an embodiment of the present disclosure. Furthermore, FIG. 5 is a cross-sectional view showing an embodiment of re-liquefying vaporized gas 2 generated in a mobility 20 during supplying of liquefied hydrogen 1 by using a hydrogen liquefaction device 100, according to an embodiment of the present disclosure; and FIG. 6 and FIG. 7 are cross-sectional views schematically showing a liquefied hydrogen supply system 10000 including a hydrogen liquefaction device 1000, according to an embodiment of the present disclosure.

As shown in FIG. 1, the hydrogen liquefaction device 1000 according to an embodiment of the present disclosure may primarily include a cradle 100 and a liquefier 200.

As shown in FIG. 1, the cradle 100 is a type of a support structure and may be formed with an accommodating space A in which a mobile storage container 10 for storing liquefied hydrogen 1 can be accommodated, being designed to be mobile, allowing movement through a wheel member 110 installed on its lower side. However, the cradle 100 is not necessarily limited to the mobile type of FIG. 1 and may also be formed as a stationary type, which does not include the wheel member 110.

The cradle 100 may be a type of frame structure having adequate strength and durability to sufficiently support a liquefier 200, which will be described later, on an upper side thereof. For example, the cradle 100 may be an integral injection structure, a casting, or a type of frame structure formed by welding or connecting together variously shaped plates, wires, pipes, vertical members, horizontal members, and inclined members. However, the cradle 100 is not necessarily limited to FIG. 1 and may have a wide variety of differently shaped members that can support the liquefier 200 on the upper side while forming the accommodating space A.

As shown in FIG. 1, a liquefier 200 is installed on an upper side of the cradle 100, and may cool hydrogen 3 in a gaseous state supplied from outside to a temperature which is equal to or below liquefaction temperature to generate liquefied hydrogen 1 in a liquid state, thereby supplying liquefied hydrogen 1 to a mobile storage container 10. Furthermore, the liquefier 200 may, simultaneously with supplying of liquefied hydrogen 1, recover vaporized gas 2 generated by heat loss from the mobile storage container 10 in which liquefied hydrogen 1 is stored, liquefy the vaporized gas 2 into liquefied hydrogen 1, and resupply the same to the mobile storage container 10.

For example, the liquefier 200 may include: a liquefaction chamber 210 that forms a liquefaction space into which hydrogen 3 in a gaseous state supplied from outside is flowed and liquified; a cryocooler 220 installed on one side of the liquefaction chamber 210 to cool hydrogen 3 to a temperature which is equal to or below liquefaction temperature so as to liquefy hydrogen 3 flowed into the liquefaction space; a supply line 240 that connects an external hydrogen supply source (not shown) and the liquefaction chamber 210 so as to supply hydrogen 3 to the liquefaction chamber 210; a discharge line 250 that connects the liquefaction chamber 210 and the mobile storage container 10 so as to supply liquefied hydrogen 1 generated in the liquefaction chamber 210 to the mobile storage container 10; a recovery line 260 that connects the mobile storage container 10 and the liquefaction chamber 210 so as to recover vaporized gas 2 generated from the mobile storage container 10 by heat loss; and a vent port 270 connected to the recovery line 260 so as to vent at least a portion of vaporized gas 2 generated and recovered from the mobile storage container 10 to outside.

More specifically, the liquefaction chamber 210 is a chamber that forms a liquefaction space in which hydrogen 3 in a gaseous state supplied from outside and vaporized gas 2 recovered from the mobile storage container 10 via the recovery line 260 are liquefied, and may be formed to be cryogenically insulated so that the liquefaction space can be smoothly maintained at a temperature which is equal to or below liquefaction temperature by the cryocooler 220. For this purpose, the liquefaction chamber 210 may have an insulating material formed to surround at least a portion of the liquefaction space.

For example, at least one of foam, aerogel, glass fiber, and vacuum insulation may be used as such insulating material. However, the material of the insulating material is not necessarily limited thereto, and any material that can insulate the liquefaction space of the liquefaction chamber 210 to cryogenic temperature may be applied.

Furthermore, the cryocooler 220 may include a compressor (not shown). The compressor is formed to be in thermal contact with one side of the liquefaction space of the liquefaction chamber 210, utilizing helium (He) as a refrigerant so as to operate near the liquefaction temperature of hydrogen of 20K, being capable of compressing helium.

Furthermore, the supply line 240 may be connected to a supply port P1 formed at an upper part of the liquefaction space, where liquefied hydrogen 1 is accommodated, so as to allow hydrogen 3 supplied from the hydrogen supply source to flow into the upper part of the liquefaction space A in the liquefaction chamber 210; and the discharge line 250 may be connected to a discharge port P2 that is formed on a lower side of the liquefaction chamber to discharge hydrogen 1 generated in the liquefaction chamber 210 to the accommodating space A by gravity.

Furthermore, the recovery line 260, during a process of recovering vaporized gas 2 generated from the mobile storage container 10 towards the liquefaction chamber, may be connected to a recovery port P3 that connects the lower side of the liquefaction chamber and the supply port, allowing vaporized gas 2 to flow into the liquefaction space in a mixed state with hydrogen 3 supplied from the hydrogen supply source; and the vent port 270 may be connected to the recovery line 260 so as to control pressure and flow rate of vaporized gas 2 that is recovered to the recovery line 260.

For example, the vent port 270 may include at least one or more following lines: a first vent line 271 including a bypass valve 271a so as to control pressure and flow rate of vaporized gas 2 recovered to the recovery line 260, and a second vent line 272 including a relief valve so that pressure of vaporized gas 2 recovered to the recovery line 260 does not exceed a predetermined pressure.

Furthermore, the vent port 270 may include a pressure gauge 273 to monitor pressure of vaporized gas 2 that is vented into the first vent line 271 or the second vent line 272, and may include a flowmeter (not shown) to monitor flow rate of vaporized gas 2 that is vented into the first vent line 271 or the second vent line 272.

Each of the supply line 240, the discharge line 250, and the recovery line 260 may be preferably formed as a double-pipe shaped vacuum hose including a vacuum-insulated space for insulation from external environment at room temperature.

By this configuration, as the liquefaction space of the liquefaction chamber 210 connected to the cryocooler 220 is cooled to a temperature which is equal to or below liquefaction temperature of hydrogen, the liquefier 200 liquefies hydrogen 3 in a gaseous state supplied via the supply line 240 into liquefied gas 1 in the liquefaction space, thereby supplying liquefied gas 1 to the mobile storage container 10 via the discharge line 250.

Due to heat loss generated in a process of generating and supplying such liquefied gas 1, vaporized gas 2 recovered from the mobile storage container 10 via the recovery line 260 may be flowed into the liquefaction space of the liquefaction chamber 210 together with hydrogen 3, re-liquefied together in a process where hydrogen 3 is liquefied, and re-supplied to the mobile storage container 10 in a liquefied gas state. At this time, in order to facilitate liquefaction of hydrogen 3 in the liquefaction space of the liquefaction chamber 210, if a generation amount of vaporized gas 2 is too high, some of vaporized gas 2 may be discharged into atmosphere via the vent port 270.

Furthermore, hydrogen 3 supplied to the liquefaction chamber 210 may be preferably supplied after being precooled to a predetermined precooling temperature (e.g., 80 K in case of a precooling module using nitrogen as a refrigerant) by a precooling module (4000 in FIG. 7) to be described later, which is installed externally for smooth liquefaction in the liquefaction space.

Accordingly, as shown in FIG. 1, the mobile storage container 10, which is installed on a moving object 11 and formed to be movable, may be supplied with liquefied hydrogen 1 from the liquefier 200 while being positioned in the accommodating space A of the cradle 100.

At this time, the liquefier 200 may open all of the valves V1, V2, V3 on the supply line 240, the discharge line 250, and the recovery line 260 so as to supply liquefied hydrogen 1 to the mobile storage container 10, to recover and re-liquefy vaporized gas 2 generated from the mobile storage container 10, and to resupply re-liquefied hydrogen to the mobile storage container 10.

Subsequently, after supplying of liquefied hydrogen 1 to the mobile storage container 10 is completed, the mobile storage container 10 installed on the moving object 11 may be disconnected from the hydrogen liquefaction device 1000 and transported to a place of use, as shown in FIG. 2.

At this time, the supply line 240, the discharge line 250, and the recovery line 260 are connected to at least one of the liquefaction chamber 210 and the mobile storage container 10 by a quick connector C, thereby facilitating disconnection of the mobile storage container 10 or installation of another mobile storage container.

In the embodiment described above, the liquefier 200 is illustrated as being installed on an upper side of the cradle 100, but is not necessarily limited to FIG. 1 and may be installed on a wide variety of locations, such as on a side of the cradle 100, which is possible to smoothly supply liquefied gas 1 to the mobile storage container 10 positioned in the accommodating space A on the cradle 100.

Furthermore, in the embodiment described above, the hydrogen liquefaction device 1000 is illustrated as supplying liquefied hydrogen 1 to the mobile storage container 10 and re-liquefying vaporized gas 3 generated in the mobile storage container 10 and resupplying it to the mobile storage container 10, but is not necessarily limited to FIG. 1 and FIG. 2 and may also supply liquefied hydrogen 1 to a mobility 20 that uses liquefied hydrogen 1 as a power source, as shown in FIG. 3.

Here, the mobility 20 may include any transport means capable of providing transport services using liquefied hydrogen 1 as a power source, such as drones, autonomous vehicles, cars, helicopters, airplanes, and the like. Furthermore, a specific configuration of the cradle 100 and the liquefier 200 may be the same as the hydrogen liquefaction device 1000 of above-described FIG. 1 and FIG. 2. Thus, a detailed description thereof is omitted.

Accordingly, as shown in FIG. 3, the mobility 20 may be supplied with liquefied hydrogen 1 from the liquefier 200 while being positioned in accommodating space A of the cradle 100.

At this time, the liquefier 200 may open all of the valves V1, V2, V3 on the supply line 240, the discharge line 250, and the recovery line 260 so as to supply liquefied hydrogen 1 to the mobility 20, to recover and re-liquefy vaporized gas 2 generated from the mobility 20, and to resupply re-liquefied hydrogen to the mobility 20.

Subsequently, after supplying of liquefied hydrogen 1 to the mobility 20 is completed, the mobility 20 may be disconnected from the hydrogen liquefaction device 1000 and used to provide a transport service, as shown in FIG. 4.

Furthermore, the hydrogen liquefaction device 1000 may be used solely to re-liquefy vaporized gas 3 generated in the mobile storage container 10 or the mobility 20 that is supplied with liquefied hydrogen 1 from another external liquefied hydrogen storage container 30.

For example, taking the mobility 20 as an example, as shown in FIG. 5, the mobility 20 may be supplied with liquefied hydrogen 1 from an external liquefied hydrogen storage container 30 while being positioned outside of the cradle 100.

At this time, the liquefier 200 may recover and re-liquefy vaporized gas generated from the mobility 20 due to heat loss in a supply process of liquefied hydrogen 1, close the valves V1, V2 on the supply line 240 and the discharge line 250 to stop supplying of hydrogen 3 and the discharge of liquefied hydrogen 1 so as to temporarily store re-liquefied hydrogen in the liquefaction chamber 210, and open only the valve V3 on the recovery line 260 to allow vaporized gas 2 to flow in. This process of re-liquefaction of vaporized gas 2 may also be performed in the same way in case of the mobile storage container 10.

In such a re-liquefaction process, the liquefied hydrogen 1 temporarily stored in the liquefaction chamber 210 by re-liquefying vaporized gas 2 may be discharged at once after connecting another storage container to the discharge line 250.

The hydrogen liquefaction device 1000 according to the above-described embodiments may, as shown in FIG. 6, be configured as a movable liquefied hydrogen supply system 10000 by being installed together with a utility module 2000 and a hydrogen supply module 4000 in a separate mobile module 3000, thereby being movable to various locations where liquefied hydrogen 1 is used.

For example, as shown in FIG. 6 and FIG. 7, the transport module 3000 may include a mobile trailer T. However, the transport module 3000 is not necessarily limited thereto, and may also be configured to be towed by or loaded on another transport means, including a container, to be movable.

The hydrogen liquefaction device 1000 according to the above-described embodiments may be installed on one portion of the transport module 3000, driven and controlled by utilities supplied from the utility module 2000, thereby generating hydrogen 3 in a gaseous state supplied from the hydrogen supply module 4000 into liquefied hydrogen 1 in a liquid state, or re-liquefying vaporized gas 2 generated in the mobile storage container 10 or the mobility 20 into liquefied hydrogen 1.

Furthermore, the utility module 2000 may be installed in the transport module 3000 to provide utilities required for the hydrogen liquefaction device 1000.

More specifically, as shown in FIG. 7, the utility module 2000 may include a vacuum pump 2200, a control unit 2400, a power supply unit 2500, a coolant chiller 2600, and a compressor 2700, etc. within the transport module 3000. Meanwhile, some utilities, such as a gas storage unit 2100 and a pneumatic unit 2300, may be provided within an explosion prevention room, which will be explained later.

For example, the gas storage unit 2100 may store utility gas that includes at least one of helium (He) to be used to purge inside and a pipe of the hydrogen liquefaction device 1000 or as a refrigerant in the cryocooler 220, nitrogen (N2) for diluting hydrogen concentration when venting vaporized gas 20, and liquid nitrogen to be used as a refrigerant in a precooling module 5000 to be described later.

The vacuum pump 2200 may form vacuum pressure of inside and the pipe of the hydrogen liquefaction device 1000.

The pneumatic unit 2300 may provide pneumatic pressure so as to allow the valves V1, V2, V3 installed on the supply line 240, the discharge line 250, and the recovery line 260 of the hydrogen liquefaction device 1000, and various valves or equipment other than said valves to be operated by pneumatic pressure. For example, the pneumatic unit 2300 may be configured as a compressed air tank for storing an air compressor and compressed air.

The control unit 2400 may control the hydrogen liquefaction device 1000. For example, the control unit 2400 may control supply and discharge of hydrogen that is supplied to the liquefier 200 of the hydrogen liquefaction device 1000 or liquefied hydrogen 1 that is discharged to the mobile storage container 10 or the mobility 20. This supply and discharge control system of the control unit 2400 can be made by monitoring temperature and pressure of the liquefier 200 of the hydrogen liquefaction device 1000 and the mobile storage container 10 or the mobility 20 or the like.

The power supply unit 2500 may supply power for operation of the hydrogen liquefaction device 1000. For example, the power supply unit 2500 may be supplied with power from an external source, distribute and supply appropriate power to each unit of the hydrogen liquefaction device 1000. This power supply unit 2500 may be required to respond to different rated outputs and operating voltages for each unit.

The coolant chiller 2600 may supply coolant to the compressor 2700 that is connected with the cryocooler 220. For example, the cryocooler 220 of the liquefier 200 included in the hydrogen liquefaction device 1000 is a device for generating cryogenic temperature at the cooling chamber 210 of the liquefier 200, and is connected to the compressor 2700 that sends and receives refrigerant to generate cryogenic temperature through compression and expansion of the refrigerant. The coolant chiller 2600 may serve to cool the coolant to a predetermined temperature, which cools the compressor 2700 that can become overheated during a process of compressing and expanding the refrigerant, and to supply the coolant.

Furthermore, as shown in FIG. 7, the hydrogen supply module 4000 may be installed in a position on another side of the transport module 3000 to store or generate hydrogen 3 in a gaseous state to be supplied to the hydrogen liquefaction device 1000.

For example, the hydrogen supply module 4000 may include a water electrolyzer 4100 that electrolyzes water to generate hydrogen 3 in a gaseous state, and a hydrogen cylinder 4200 that stores hydrogen 3 in a gaseous state, thereby storing or generating hydrogen 3 in a gaseous state to be supplied to the hydrogen liquefaction device 1000.

In this embodiment, the hydrogen supply module 4000 is illustrated as including both the water electrolyzer 4100 and the hydrogen cylinder 4200, but is not necessarily limited thereto, and may include only the water electrolyzer 4100 to directly supply hydrogen 3 that is generated therein, or may include only the hydrogen cylinder 4200 to supply hydrogen 3 that has been stored in advance.

Furthermore, as shown in FIG. 7, the hydrogen supply system 10000 may include a precooling module 5000, which is installed on the supply line 240, to precool hydrogen 3 supplied to the liquefaction chamber 210 of the hydrogen liquefaction device 1000.

Accordingly, the hydrogen liquefaction device 1000 may be supplied with hydrogen 3 that has been precooled to a predetermined precooling temperature (e.g., 80 K in case of using liquid nitrogen as a refrigerant) in the precooling module 5000, thereby facilitating the cooling of hydrogen 3 in the liquefier 200 to be performed more smoothly with higher thermal efficiency.

Furthermore, as shown in FIG. 7, the transport module 3000 may form an explosion prevention room in a shape surrounded by an explosion protection wall W so that an area where the hydrogen liquefaction device 1000 is installed, an area where the hydrogen supply module 4000 is installed, and an area where utilities, such as the gas storage unit 2100 and the pneumatic unit 2300, are installed can be formed as an explosion protection area.

For example, the explosion protection area by the explosion protection wall W may be formed in a flame-proof “d” structure that can withstand explosion pressure and prevent propagation of flames to external explosive atmosphere in case of an internal explosion caused by hydrogen 3 leakage.

Furthermore, the transport module 3000 may have a detecting sensor S installed in the explosion protection area, so that hydrogen 3 leaked inside the explosion protection area can be detected in advance, and the explosion protection wall W may have an outside air inlet window and a ventilator installed to facilitate ventilation inside the explosion protection area.

Therefore, according to the hydrogen liquefaction device 1000 and liquefied hydrogen supply system 10000 according to various embodiments of the present disclosure, a hydrogen liquefaction device 1000 and liquefied hydrogen supply system 10000, which is capable of including utilities required for liquefaction of hydrogen, a power supply unit, a coolant chiller, a pneumatic unit, a control system, an explosion protection safety device, and the like, which are downsized, inside a container that is movable by a mobile trailer T or a transport means; capable of separating a storage container thereby storing liquefied hydrogen as needed and using liquefied hydrogen immediately; and capable of re-liquefying vaporized gas generated by heat loss to use liquefied hydrogen easily without loss of hydrogen gas, can be implemented.

Although the above has shown and described various embodiments of the present disclosure, the present disclosure is not limited to the specific embodiments described above. The above-described embodiments can be variously modified and implemented by those skilled in the art to which the present disclosure pertains without departing from the gist of the present disclosure claimed in the appended claims, and these modified embodiments should not be understood separately from the technical spirit or scope of the present disclosure. Therefore, the technical scope of the present disclosure should be defined only by the appended claims.

In the embodiments disclosed herein, arrangement of illustrated components may vary depending on requirements or environment in which the disclosure is implemented. For example, some components may be omitted or some components may be integrated and implemented as one.

What is claimed is:

1. A hydrogen liquefaction device comprising:
a cradle for forming an accommodating space in which a mobile storage container capable of storing liquefied hydrogen or a mobility that uses liquefied hydrogen as a power source can be accommodated; and
a liquefier installed on one side of the cradle, cooling hydrogen in a gaseous state supplied from outside to a temperature which is equal to or below liquefaction temperature to generate liquefied hydrogen in a liquid state so as to supply liquefied hydrogen to the mobile storage container or the mobility, or recover vaporized gas generated from the mobile storage container in which liquefied hydrogen is stored or from the mobility for re-liquefaction into liquefied hydrogen.

2. The hydrogen liquefaction device according to claim 1,
wherein the liquefier includes:
a liquefaction chamber that forms a liquefaction space into which hydrogen in a gaseous state supplied from outside is flowed and liquified;
a cryocooler installed on one side of the liquefaction chamber, cooling hydrogen to a temperature which is equal to or below liquefaction temperature so as to liquefy hydrogen flowed into the liquefaction space;
a supply line that connects an external hydrogen supply source and the liquefaction chamber so as to supply hydrogen to the liquefaction chamber;
a discharge line that connects the liquefaction chamber and the mobile storage container, or connects the liquefaction chamber and the mobility, so as to supply liquefied hydrogen generated in the liquefaction chamber to the mobile storage container or to the mobility; and
a recovery line that connects the mobile storage container and the liquefaction chamber, or connects the mobility and the liquefaction chamber, so as to recover vaporized gas generated from the mobile storage container or the mobility.

3. The hydrogen liquefaction device according to claim 2,
wherein the supply line is connected to a supply port formed at an upper part of the liquefaction space, where liquefied hydrogen is accommodated, in the liquefaction chamber, so as to allow hydrogen supplied from the hydrogen supply source to flow into the upper part of the liquefaction space, and
the discharge line is connected to a discharge port that is formed on a lower side of the liquefaction chamber, so as to discharge hydrogen generated in the liquefaction chamber to the accommodating space.

4. The hydrogen liquefaction device according to claim 3,
wherein the recovery line, during a process of recovering vaporized gas generated from the mobile storage container or the mobility towards the liquefaction chamber, is connected to a recovery port that connects the lower side of the liquefaction chamber and the supply port, so as to allow vaporized gas to flow into the liquefaction space in a mixed state with hydrogen supplied from the hydrogen supply source.

5. The hydrogen liquefaction device according to claim 2,
wherein the liquefier further includes a vent port connected to the recovery line so as to vent at least a portion of vaporized gas generated and recovered from the mobile storage container or the mobility to outside.

6. The hydrogen liquefaction device according to claim 5,
wherein the vent port includes at least one or more following lines:
a first vent line including a bypass valve so as to control pressure and flow rate of vaporized gas recovered to the recovery line; and
a second vent line including a relief valve so that pressure of vaporized gas recovered to the recovery line does not exceed a predetermined pressure.

7. The hydrogen liquefaction device according to claim 2,
wherein the supply line, the discharge line, and the recovery line are connected to the liquefaction chamber, and to at least one of the mobile storage container and the mobility by a quick connector.

8. The hydrogen liquefaction device according to claim 2,
wherein each of the supply line, the discharge line, and the recovery line is formed as a double-pipe shaped vacuum hose including a vacuum-insulated space.

9. The hydrogen liquefaction device according to claim 2,
wherein the mobile storage container or the mobility is configured to be supplied with liquefied hydrogen from the liquefier while being positioned in the accommodating space of the cradle.

10. The hydrogen liquefaction device according to claim 9,
wherein the liquefier is configured to open all valves on the supply line, the discharge line, and the recovery line so as to supply liquefied hydrogen to the mobile storage container or the mobility, to recover and re-liquefy vaporized gas generated from the mobile storage container or the mobility, and to resupply re-liquefied hydrogen to the mobile storage container or the mobility.

11. The hydrogen liquefaction device according to claim 2,
wherein the mobile storage container or the mobility is configured to be supplied with liquefied hydrogen from an external liquefied hydrogen storage container while being positioned outside the cradle.

12. The hydrogen liquefaction device according to claim 11,
wherein the liquefier is configured to close the valves on the supply line and the discharge line and to open the valve on the recovery line so as to recover and re-liquefy vaporized gas generated from the mobile storage container or the mobility to temporarily store re-liquefied hydrogen in the liquefaction chamber.

13. A liquefied hydrogen supply system comprising:
a transport module including a mobile trailer or a container that is movable by being towed by a transport means or loaded on the transport means;
a hydrogen liquefaction device installed on one side of the transport module to generate hydrogen in a gaseous state into liquefied hydrogen in a liquid state;
a utility module installed on other side of the transport module to supply utilities required for the hydrogen liquefaction device; and
a hydrogen supply module installed on another side of the transport module to store or generate hydrogen in a gaseous state to be supplied to the hydrogen liquefaction device,
wherein the hydrogen liquefaction device includes:
a cradle that forms an accommodating space in which a mobile storage container capable of storing liquefied hydrogen or a mobility that uses liquefied hydrogen as a power source can be accommodated, being formed to be movable; and
a liquefier installed on one side of the cradle, cooling hydrogen in a gaseous state supplied from the hydrogen supply module to a temperature which is equal to or below liquefaction temperature to generate liquefied hydrogen in a liquid state so as to supply liquefied hydrogen to the mobile storage container or the mobility, or recover vaporized gas generated from the mobile storage container in which liquefied hydrogen is stored or from the mobility for re-liquefaction into liquefied hydrogen.

14. The liquefied hydrogen supply system according to claim 13,
wherein the liquefier includes:
a liquefaction chamber that forms a liquefaction space into which hydrogen in a gaseous state supplied from the hydrogen supply module is flowed and liquified;
a cryocooler installed on one side of the liquefaction chamber, cooling hydrogen to a temperature which is equal to or below liquefaction temperature so as to liquefy hydrogen flowed into the liquefaction space;
a supply line that connects the hydrogen supply module and the liquefaction chamber so as to supply hydrogen to the liquefaction chamber;
a discharge line that connects the liquefaction chamber and the mobile storage container, or connects the liquefaction chamber and the mobility, so as to supply liquefied hydrogen generated in the liquefaction chamber to the mobile storage container or to the mobility; and
a recovery line that connects the mobile storage container and the liquefaction chamber, or connects the mobility and the liquefaction chamber, so as to recover vaporized gas generated from the mobile storage container or the mobility.

15. The liquefied hydrogen supply system according to claim 14,
further comprising a precooling module installed on the supply line to precool hydrogen that is supplied to the liquefaction chamber.

16. The liquefied hydrogen supply system according to claim 15,
wherein the utility module includes:
a vacuum pump that forms vacuum pressure of inside and a pipe of the hydrogen liquefaction device;
a control unit that controls the hydrogen liquefaction device;
a power supply unit that supplies power for operation of the hydrogen liquefaction device; and
a coolant chiller that supplies coolant to the compressor of the cryocooler, and
further including following utilities formed in an explosion prevention area:
a gas storage unit that stores utility gas that includes at least one of helium (He) to be used to purge inside and the pipe of the hydrogen liquefaction device or as a refrigerant in the cryocooler, nitrogen (N2) for diluting hydrogen concentration when venting vaporized gas, and liquid nitrogen (LN2) to be used as a refrigerant in the precooling module; and
a pneumatic unit that provides pneumatic pressure so as to allow valves installed on the supply line, the discharge line, and the recovery line to be operated by pneumatic pressure.

17. The liquefied hydrogen supply system according to claim 13,
wherein the hydrogen supply module includes at least one of:
a water electrolyzer that electrolyzes water to produce hydrogen in a gaseous state; and
a hydrogen cylinder that stores hydrogen in a gaseous state.

18. The liquefied hydrogen supply system according to claim 13,
wherein the transport module forms an explosion prevention area, which includes an area where the hydrogen liquefaction device is installed, an area where the hydrogen supply module is installed, and an area where a gas storage unit and a pneumatic unit are installed.

19. The liquefied hydrogen supply system according to claim 18,
wherein the transport module includes a detecting sensor installed in the explosion protection area to detect hydrogen leaked inside the explosion protection area.

20. A hydrogen liquefaction device comprising:
a cradle that forms an accommodating space in which a mobile storage container capable of storing liquefied hydrogen or a mobility that uses liquefied hydrogen as a power source can be accommodated, being formed to be movable; and
a liquefier installed on one side of the cradle, cooling hydrogen in a gaseous state supplied from outside to a temperature which is equal to or below liquefaction temperature to generate liquefied hydrogen in a liquid state so as to supply liquefied hydrogen to the mobile storage container or the mobility, or recover vaporized gas generated from the mobile storage container in which liquefied hydrogen is stored or from the mobility for re-liquefaction into liquefied hydrogen;
wherein the liquefier includes:
a liquefaction chamber that forms a liquefaction space into which hydrogen in a gaseous state supplied from outside is flowed and liquified;
a cryocooler installed on one side of the liquefaction chamber, cooling hydrogen to a temperature which is equal to or below liquefaction temperature so as to liquefy hydrogen flowed into the liquefaction space;
a supply line that connects an external hydrogen supply source and the liquefaction chamber so as to supply hydrogen to the liquefaction chamber;
a discharge line that connects the liquefaction chamber and the mobile storage container, or connects the liquefaction chamber and the mobility so as to supply liquefied hydrogen generated in the liquefaction chamber to the mobile storage container or to the mobility;
a recovery line that connects the mobile storage container and the liquefaction chamber, or connects the mobility and the liquefaction chamber, so as to recover vaporized gas generated from the mobile storage container or the mobility; and
a vent port connected to the recovery line so as to vent at least a portion of vaporized gas generated and recovered from the mobile storage container or the mobility to outside;
wherein the supply line is connected to a supply port formed at an upper part of the liquefaction space, where liquefied hydrogen is accommodated, in the liquefaction chamber, so as to allow hydrogen supplied from the hydrogen supply source to flow into the upper part of the liquefaction space,
the discharge line is connected to a discharge port that is formed on a lower side of the liquefaction chamber, so as to discharge hydrogen generated in the liquefaction chamber to the accommodating space,
the recovery line, during a process of recovering vaporized gas generated from the mobile storage container or the mobility towards the liquefaction chamber, is connected to a recovery port that connects the lower side of the liquefaction chamber and the supply port, so as to allow vaporized gas to flow into the liquefaction space in a mixed state with hydrogen supplied from the hydrogen supply source, and
the vent port includes at least one or more following lines:
a first vent line including a bypass valve so as to control pressure and flow rate of vaporized gas recovered to the recovery line; and
a second vent line including a relief valve so that pressure of vaporized gas recovered to the recovery line does not exceed a predetermined pressure.
